(19) United States
(12) Patent Application Publication
(10) Pub. No.: US 2008/0156200 A1
(43) Pub. Date: Jul. 3, 2008

(54) Sole For A Bakery Oven And Oven Comprising One Such Sole

(75) Inventor: Bernard Zorn, Saverne (FR)

Correspondence Address: EGBERT LAW OFFICES, 412 MAIN STREET, 7TH FLOOR, HOUSTON, TX, 77002, US

(73) Assignee: MECATHERM, Societe Anonyme, Barembach (FR)

(21) Appl. No.: 11/816,164

(22) PCT Filed: Feb. 14, 2006
(86) PCT No.: PCT/FR2006/050132

§ 371 Date: Aug. 13, 2007

(30) Foreign Application Priority Data
Feb. 15, 2005 (FR) 0550431
Apr. 14, 2005 (FR) 0550956

(51) Int. Cl. A47J 37/00

(52) U.S. Cl. 99/423

(57) ABSTRACT

The invention relates to a sole for a bakery oven, wherein the bakery oven has at least one chamber for cooking baked products, Viennese bakery products, pastry products or similar. The inventive sole includes a woven mesh structure having wires and cables of stainless steel or similar. The invention also relates to a bakery oven having one such sole.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention relates to a sole for a bakery oven and an oven provided with such a sole.

It is to be used for cooking bakery, Viennese bakery, pastry products or the like, in a plant including at least one baking chamber.

Said products rest on this mobile or fixed sole during baking, either directly, or through an adapted baking support, such as a plate, a rack or a baking mold, or the like.

Sole-heating means can be provided for under said sole.

2. Description of Related Art Including Information Disclosed Under 37 CFR 1.97 and 37 CFR 1.98

There are already known baking devices corresponding to the above description, the operation of which is discontinuous or continuous. In the first case, the oven is capable of containing a certain quantity of products called a batch. It is taken out therefrom after baking is finished, leaving room for baking another batch. In the case of a continuous baking oven, products are conveyed through the baking chamber by appropriate conveying means between an inlet and an outlet, the transit time corresponding to the baking time.

For charging and evacuation of a batch of products in discontinuously operating ovens or for the transit of said products through continuously operating ovens, the sole of the baking chamber, on which said products rest, either directly, or through an adapted baking support, such as a plate, a rack or a baking mold, can be mobile, for example in the form of a sliding tray, namely in the case of a sole called outgoing sole, or of an appropriate baking belt. Said belt can be made of metal or synthetic material or can also have articulated strips made of stone or metal.

The ovens this invention refers to in particular are those in which the products to be baked are into direct contact or into contact through their baking support with the sole of the baking chamber, the sole being subjected to appropriate heating means.

In particular, under this sole can be installed heating elements, heating-fluid conduits or any other heat-generating means.

Further in this description, said heating means, extending at least partially under the sole, will be called a sole-heating plate.

The products are thus baked partly by conduction through this sole, considering that they further undergo baking by radiant heating and/or by convection.

The radiation results from the dispersion of heat from the sole and from the vault of the baking chamber charged with heat. In this respect, the vault, too, is capable of being provided with heating means.

These products can also be baked by convection by a heat-transfer fluid circulating in the baking chamber. Certain ovens implement each one of these heating modes (conduction, radiation, convection) to ensure the baking of the products. In particular, this consists, in an oven as described above comprising a sole and a vault that can be heated, in subjecting the air of the baking chamber to appropriate mixing means.

When the products are placed directly on the sole, the calories are directly absorbed by the products in the contact zone so that, locally, the sole should be recharged with heat energy by means of the sole-heating plate so that the baking operation can continue. Heating the sole by simple radiation through said sole-heating plate involves a certain inertia which has the effect of slowing down the baking operation by conduction and by radiation through the sole. The phenomenon is intensified when the products rest on this sole through baking supports which, although generally being open-worked, create a barrier to heating by radiation and increase the inertia of calories transfer by conduction from the sole toward the products.

The result is baking that is not made in identical conditions on the top and sides of the products with respect to the bottom of the latter, in direct or indirect contact with the sole.

The energy-transfer mode is extremely important for the proper progress of the baking process, in which the sequence of heat-energy communication complies with strict rules, in order to obtain products having a good gustatory quality and a good appearance, in particular at the level of the crust.

The thermal inertia of the conveyance and baking means should be adapted to this process.

Known are conveying belts for ovens composed of metal links, chainmail, chain links, articulated rafters, flat articulated links and the like. These belts are heavy, from 15 to 30 kg/m². They have, therefore, a great thermal inertia.

In this connection, there is known from EP0.934.699 a baking device including such a chain in the form of articulated rafters.

When a product is placed on such heavy and very hot metal belts, energy transfer is almost instantaneous. There is therefore an immediate formation of crust, combined with a marking of the product, such as marking with hot iron, imprinting the rough raised design of the structure of the belt on the product. This phenomenon is called branding of the bread and is comparable to a local burn.

When, on the contrary, a product is placed on such a heavy metal belt coming out cold from a return circuit of a tunnel oven for example, the product, in its doughy state, has the time to be impregnated into the structure of the belt matching the latter's design before hardening during the baking operation. The result thereof is a deep marking of the product at the level of its lower surface.

Also known are plate belts (with a morphology comparable to piano hinges), the profile of which has the advantage of not marking the product. On the other hand, these belts having even greater weight only increase the disadvantages mentioned above. As a matter of fact, it is impossible to put the products on plates at optimal baking temperature of the sole. The belt should therefore be brought very quickly to the desired temperature after placing the products, through heating means having an enhanced power in order to compensate for the inertia. Therefore, one must perform temperature adjustments, which do not permit optimal baking results.

Finally, there are known belts including stone soles that are generally heated at the level of the return circuit of said belt. These soles ensure good baking conditions, since the use of stone avoids the disadvantage of the branding, and therefore of an instantaneous heat transfer as in the case of a metal support, and permits maintaining good baking conditions. On the other hand, such belts, of a considerable weight, are also characterized by a very large size, and great diameters of guide rollers, in the range of 600 to 800 mm.

These large diameters, just as those for metal belts (commonly in the range of 300 mm) make the operations of transferring and placing the products with the saber difficult.

The heavy systems that cannot operate sequentially require sophisticated charging devices. This technique does not permit superposition of several tiers at the level of the oven.

Because of their inertia, these heavy systems are also ill-adapted to production changes. In fact, the different products can require quite different temperatures and baking conditions. Thus, the result of thermal inertia of the sole of an oven is long heating or cooling times during which the production should necessarily be interrupted.

The heavy belts also have disadvantages with respect to the mechanical constraints associated thereto. Their tension is obtained by a positive drive, generally by means of drive chains with which they are provided along the lateral edges. Lubrication of such chains is difficult in chambers where the temperature can exceed 300° C. It requires very expensive lubricants that, not only, should be in conformity with strict alimentary standards, but, also, should be adapted to such temperatures, still representing a not inconsiderable combustion risk, especially at the end of baking. In fact, the oven being then empty of products and therefore deprived of a batch toward which the energy can be evacuated, the latter is diffused to the very structure of the existing components in the heating chamber, the temperature of which can exceed acceptable thresholds with respect to the lubricant used.

### BRIEF SUMMARY OF THE INVENTION

This invention tries to solve all of the above disadvantages of the state of the art by providing a solution to overcome the problem of inertia of the recharging with heat energy of a sole or problem of calorie transfer in the direction of the products to ensure their baking in optimal conditions.

Within the framework of a first inventive step, one has considered the possibility of creating a light sole having small thermal inertia.

To this end, the invention relates to a sole for a bakery oven, designed to be used for cooking bakery items, Viennese bakery items, pastry products or the like, in a plant including at least one baking chamber, characterized in that it includes a woven mesh structure made of stainless steel wire and cable or the like.

Said products rest on this mobile or fixed sole during baking, either directly, or through an adapted baking support, such as a plate, a rack or a baking mold, or the like. Sole-heating means are placed under said sole.

In addition, the sole is heated by radiation and/or convection and/or conduction by sole-heating means.

According to other features of the invention, the sole is permeable for additional heating of the products by convection through said sole.

Advantageously, the sole, in the form of a mobile sole belt moving in a closed circuit winding around at least one downstream guide roller and an upstream guide roller, is capable of being driven by friction.

The tensile strength of the sole according to the invention is ensured by at least one cable, preferably several cables, in the direction of the chain corresponding to the direction of running of this sole when it is in the form of a mobile belt.

The invention also relates to a baking oven comprised of one or several modules, each module comprising a baking chamber, at least the baking chamber of one of the modules including a sole according to the invention.

The invention will be better understood when reading the following detailed description, with reference to the attached figures.

### BRIEF DESCRIPTION OF THE SEVERAL VIEWS OF THE DRAWINGS

FIG. 1 represents a schematic view of an embodiment of a sole according to the invention.

FIG. 2 represents a schematic and a cross-section views of a sole according to the invention, in the form of a sole belt describing a closed circuit and subjected to advantageous means for putting under tension acting on a tensioning roller.

FIG. 3 is a schematic view similar to FIG. 2, illustrating the sole belt and the means for putting under tension, which act on one of the two guide rollers around which said belt partially winds.

### DETAILED DESCRIPTION OF THE INVENTION

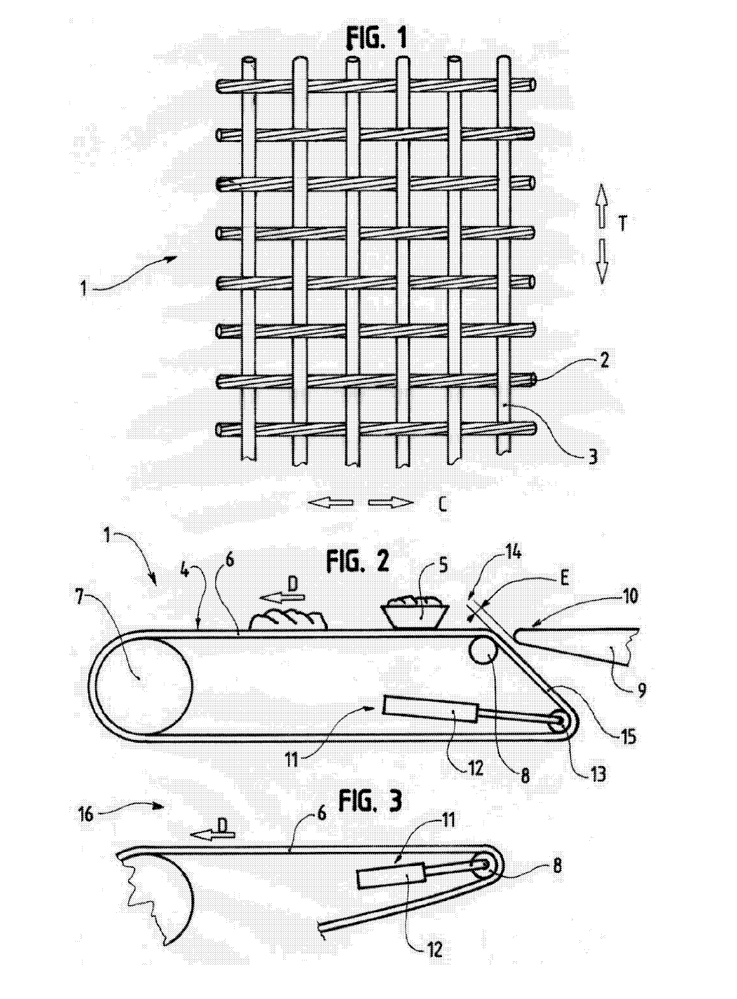

Subsequently in the description, reference is made to FIGS. 1 through 3 of the attached drawings.

The invention relates to a sole 1 for a bakery oven (not represented), designed to be used for cooking bakery items, Viennese bakery, pastry products or the like, in a plant including at least one baking chamber.

According to the invention, this sole 1 includes a woven mesh structure of stainless steel wires and cables or the like.

In a preferred embodiment, this sole 1 is obtained as a result of the twisting of the cables 2 in the direction of the chain C, corresponding to the direction of progress of the products in the case of a mobile sole 1 in the form of a moving sole belt, and of the wires 3 in the direction of the weft T.

These cables 2 and wires 3 are preferably made of stainless steel. The invention is not limited at all to this choice of material and can be extended to other materials capable of supporting, without deteriorating their mechanical qualities, the usual temperature range in the plants for bakery and pastry products, in particular maximum baking temperatures that can exceed 300° C.

The implementation method for making an apparently woven mesh structure can be weaving, twisting, knitting, or the like.

The structure of this sole 1 is essentially designed so as to minimize its thermal inertia. It therefore resorts to cables 2 and wires 3 of small cross-section, so as to obtain a weight and, thus, a thermal inertia considerably lower with respect to the old heavy belts.

In a particular exemplary embodiment, the sole 1, according to the invention, incorporates cables 2 and/or wires 3 of an equivalent cross-section and a small diameter, in particular less than 0.8 mm. The space between said cables 2 and/or between said wires 3, in the direction of the chain C, respectively of the weft T, is of the same range as the diameter of said wires 3 or cables 2 themselves, in particular making sure that the largest spacing between two consecutive cables 2 or wires 3 does not exceed four times the smallest diameter of a cable 2 and/or of a wire 3.

The sheet thus obtained permits use of a sole 1 with a mass lower than 5 Kg per m², preferably varying between 2 and 3 kg per m², and therefore with a particularly small thermal inertia.

According to a characteristic feature of the invention, the sole 1 is permeable in order to permit additional heating by convection of the products which rest directly on the upper face 4 or through appropriate baking supports 5.

The thermal inertia of a sole 1 including such a structure is particularly low.

Thus, it is henceforth possible, due to the lack of considerable inertia in this structure according to the invention, to avoid the disadvantage of the branding, specific to heavy metal belts. In particular, this permits, from the very entry into the oven, a perfect control of temperature gradients on the surface and in the core of the products, maintaining strictly optimal baking conditions.

Since the structure of the meshwork of the sole is very close and similar to a cloth, its surface is smooth and even. Hence, the product does not undergo marking before its superficial resistance becomes sufficient, which takes place rapidly inasmuch as baking, without branding, can start immediately after placing the products on this sole, in conformity with the optimal cycles of temperature gradients and maintaining at temperature.

It should be noted that this sole, though permitting its heating by radiation, also permits its heating by convection of heat-transfer fluid in a closed circulation underneath, between a suction inlet, at one end of this sole, and a discharge outlet, at the opposite end. In particular, its finely woven or twisted structure contributes to the conveying of said heat-transfer fluid between the sole and said heating means, also called a sole-heating plate.

Furthermore, because of the permeability of the sole 1, the fluid for heating by convection, circulating in the zone located under the sole 1, can lick the products resting on the latter directly or through baking supports 5, without modifying the baking conditions of the products on their top.

Although this invention is applicable to fixed-sole baking devices, it will also be extremely useful in mobile-sole baking devices, in particular those based on continuous baking of the type tunnel oven. In this case, the sole 1 is in the form of a belt, called a sole belt.

The following description will refer in particular to such sole-belt devices 6 moving in a closed circuit as shown in FIGS. 2 and 3.

The constitution of such a sole belt 6, in the form of a meshwork as described above, has the advantage of making said belt capable of winding around guide rollers 7, 8 of a small diameter, in the range of 100 to 200 mm.

Such an arrangement is favorable for placing the products on said sole belt 6 or their transfer to another work station downstream with respect to the bread-baking line. Thus, the products are usually placed on such a belt by means of a tool called saber 9.

When winding of the belt occurs on a large-diameter guide roller, the end 10 of said saber 9 cannot get closer beyond a minimum distance to the belt if it is located in the same plane as the latter. In order to avoid the products, in their doughy state, from falling between the belt and said saber, the latter is quite often raised so as to be positioned slightly above the belt. However, by thus letting the products fall on said belt, even from a small height, they can be deteriorated or deformed.

The winding on a reduced-cross-section guide roller 8, as it is possible through this invention, permits to minimization of the distance E between the sole belt 6 and the saber 9, yet maintains the latter in the same conveyance plane defined by said belt. This permits transfer of the products without any deterioration or marking.

The use of a very fine sole belt 6, according to the invention, is against an old prejudice with respect to such belts considered too fragile.

The light structure has nevertheless a sufficient mechanical resistance in the direction D of running of the belt, thanks to the use of chain C cables 2, such as explained above.

In order to preserve the lightness of said sole belt 6, the positive drive system by means of chains has been removed, thereby eliminating all disadvantages and risks connected with the constraints regarding the lubrication of said devices.

In fact, said sole belt 6 is driven by friction through its putting under tension between the two guide rollers 7, 8 located at the ends of its trajectory. In general, said guide rollers 7, 8 are placed on both sides of the baking chamber the belt 6 has to traverse. In this connection, there are means associated to the latter for automatic putting under tension 11 that will advantageously compensate for the dilation phenomena resulting from temperature variations.

These means for automatic putting under tension 11 are preferably comprised of at least one jack 12, acting on one of the guide rollers 8 (see FIG. 3) or on a specific tensioning roller 13 about which the sole belt 6 partially winds. In particular, this tensioning roller 13 is located in front of and under the guide roller 8 placed at the end 14 upstream with respect to the sole belt 6. Thus, the latter describes, between said tensioning roller 13 and said upstream guide roller 8, an ascending inclined plane 15 extending under the product removal saber 9.

This arrangement permits control of the lateral position of the sole belt 6 even before the latter is taken up by the upstream guide roller 8 and, therefore, on its entire conveyance length extending between this upstream guide roller 8 and the downstream guide roller 7. In particular, said means for putting under tension 11 also advantageously constitute means for adjusting the alignment of the roller 8, 13 on which they act with respect to the alignment of the sole belt 6. In fact, these means for putting under tension 11 includes at least two jacks 12 capable of acting on both sides of said guide 8 or tensioning 13 roller in order to adjust its alignment with respect to the belt 6, these jacks 12 being controlled in particular by means for detecting 16 the state of alignment of the belt.

Such detection means 16 can be optical and/or mechanical and are designed for detecting lateral overflowing of said belt 6 and, thus, controlling either one of the jacks 12 that, by acting on the alignment of the roller 8, 13, ensure the appropriate realignment of said belt 6.

As already mentioned above, a sole 1 according to the invention can find its application in any type of mobile or fixed bakery oven, for example, and in a non-exhaustive way, in tunnel ovens having one or several tiers, or traditional ovens.

In this connection, the invention also relates to another oven comprised of one or several modules, each module comprising a baking chamber, at least the baking chamber of one of said modules including a mobile or fixed sole, as described above.

What is claimed:

1. Sole (1) for a bakery oven including at least one chamber for cooking bakery, Viennese bakery, pastry products or the like, characterized in that it includes a woven-mesh structure made of stainless steel wires (3) and cables (2) or the like.

2. Sole (1) according to claim 1, characterized in that said cables (2) and/or wires (3) are of an equivalent cross-section and of a diameter less than 0.8 mm, the spacing between said cables (2) and/or wires (3) being less than four times the diameter of a cable (2) and/or of a wire (3).

3. Sole (1) according to any of the preceding claims, characterized in that it has a mass of 5 kg/m², preferably varying between 2 and 3 kg/m².

4. Sole (1) according to any of the preceding claims, characterized in that it is permeable for additional heating by convection of the products resting on this sole (1).

5. Sole (1) according to any of the preceding claims, characterized in that it is mobile and is defined by a sole belt moving in a closed circuit winding at least about one downstream guide roller (7) and one upstream guide roller (8).

6. Sole (1) according to claim 5, characterized in that the cables (2) extend in the direction of the chain C, corresponding to the direction of running (D) of the sole belt (6), the wires (3) extending in the direction of the weft T.

7. Sole (1) according to claim 5 or 6, characterized in that at least the upstream guide roller (8) is defined of a cross-section less than 200 mm.

8. Sole (1) according to any of the claims 5 through 7, characterized in that the sole belt (6) is driven by friction and subjected to automatic means for putting under tension (11).

9. Sole (1) according to claim 8, characterized in that the automatic means for putting under tension (11) are comprised of at least one jack (12) acting on one of the guide rollers (8) or one tensioning roller (13) about which said sole belt (6) partially winds.

10. Sole (1) according to claim 9, characterized in that the tensioning roller (13) is located in front of and under the upstream guide roller (8) causing the sole belt (6) to describe an ascending inclined plane (15) between the tensioning roller (13) and the upstream guide roller (8).

11. Sole (1) according to any of the claims 8 through 10, characterized in that the means for putting under tension (11) constitute means for adjusting the alignment of the return (8) or tensioning (13) roller, as the case may be, for adjusting the lateral position of the sole belt (6).

12. Sole (1) according to claim 11, characterized in that the means for putting under tension (11) include at least two jacks (12) designed capable of acting on both sides of said guide (8) or tensioning (13) roller in order to adjust its alignment with respect to the sole belt (6).

13. Sole (1) according to any of the preceding claims, characterized in that the means for putting under tension (11) are controlled by means for detecting (16) the state of alignment of the sole belt (6).

14. Bakery oven including a sole according to any of the preceding claims.
